(19) United States
(12) Patent Application Publication
(10) Pub. No.: US 2017/0109853 A1
(43) Pub. Date: Apr. 20, 2017

(54) Methods And Systems For Verification Of A User's Identity

(71) Applicant: Andromaque J. Ferdinand, Brookfield, CT (US)

(72) Inventor: Andromaque J. Ferdinand, Brookfield, CT (US)

(21) Appl. No.: 15/160,527

(22) Filed: May 20, 2016

Related U.S. Application Data
(60) Provisional application No. 62/135,808, filed on Mar. 20, 2015.

(51) Int. Cl. G06Q 50/26; H04L 29/06

(52) U.S. Cl. CPC G06Q 50/265; H04L 63/08

(57) ABSTRACT

Methods and systems for verification of a user's identity. Such methods and systems are used in dating websites, social media and generally on the internet. Methods and systems involving using photographs, videos and/or cross linking to third party websites in order to verify a user's identity and to provide a “verified” stamp of approval for a user.

### FIELD OF THE INVENTION

Methods and systems for verification of a user's identity in order to prevent and/or deter catfishing. Such methods and systems are used in dating websites, social media and generally on the Internet.

### BACKGROUND OF THE INVENTION

Catfishing is when someone creates a false identity using social media to pursue a deceptive online relationship or for fraudulent or vengeful purposes.

According to Facebook® the number of false profiles on the Internet could lie anywhere from 58 billion to 108 billion. This is a very real issue for the social media sites, as false identities can compromise the integrity of the sites. According to an interview with CNN, Facebook's chief security officer Joe Sullivan explains “On Facebook we have a really large commitment in general to finding and disabling false accounts.” He also explains “Our entire platform is based on people using their real identities.”

On Facebook®, as of September 2014 there are 1.35 billion MAU—monthly active users, 864 million DAU—daily active users, 1.2 billion MAMU—monthly active mobile users, 703 million DAMU—daily active mobile users and 73.44% of daily user base access from mobile device.

As of September 2013, it is believed that there are 67.65 million-137.76 million duplicate or false user accounts, which amounts to a rate of 5.5% to 11.2% are Fake accounts on Facebook®.

About 4.3 percent to 7.9 percent of accounts were duplicates (meaning someone has created more than one account for an individual), or anywhere between 52.89 million and 97.17 million. About 0.8 percent to 2.1 percent were misclassified (meaning someone has created an account for something not someone), or anywhere between 9.84 million and 25.83 million. About 0.4 percent to 1.2 percent were undesirable (meaning accounts created to violate Facebook's rules), or anywhere between 4.92 million and 14.76 million.

While it is hard to say exactly how many Catfishing incidents there have been on Facebook®, there are some alarming statistics found on the web and specifically in the arena of online dating.

About 20 million people visit a dating site at least once a month and online dating is responsible for 120,000 marriages every year. Furthermore, 10% of Americans use an online dating services and 1 in 4 couples meet online. Furthermore, Americans spend about $500 million a year searching for a romantic partner, which amounts to an average spent on a dating site per user is approximately $239 per year. The dating site eHarmony has about 20 million users, Match.com has about 15 million users and the dating industry creates a yearly revenue of $1.049 billion.

In 2011 the FBI received 5,600 complaints from victims of scammers. Victims reported $50.4 million in collective losses. The FBI claims this number is higher, since many victims are embarrassed to report their loss. The U.S. Embassy to Russia claims that one person a day reports concerns that a Russian single, who is in fact a catfish has duped them.

Thus, catfishing and duping users is a real and significant problem that affects dating websites, social media and use on the Internet. The problem is linked to the Internet where there are specific challenges faced that are not faced in conventional business.

Accordingly, it is desirable to provide a method and system to assure users on the Internet that they are communicating with a real person prior to having to meet the person in real life.

There exists a need to address the problems of catfishing and duping of users on the Internet, and the invention is aimed at addressing this problem.

### SUMMARY OF THE INVENTION

To improve upon the prior art, it is an object of the invention to provide methods and systems for verification of a user's identity in order to prevent and/or deter catfishing. Such methods and systems are used in dating websites, social media and generally on the Internet.

Objects of the presently claimed invention is directed solving these issues. Objects of the presently claimed invention are directed to helping social media, dating and other Internet sites to verify the authenticity of users.

Other objects of the invention involve allowing a person to verify the identity of another person prior to meeting that person in real life. Other objects of the invention involve providing additional security and measures to prevent a person from being duped on the Internet.

These and other objects of the invention are achieved by providing a system for verifying a user identity, the system comprising: a server; at least one database in communications with said server; at least one computer in communication with said server via the Internet; software executing on said server to receive a user handle from the at least one computer, the user handle associated with a particular user identity; software executing on said server to conduct an identity test to verify the authenticity of the user handle; and software executing on said server to award an electronic confirmation that the user identity has been verified to be authentic and transmitting the award notification to said at least one computer.

In certain embodiments, the system further comprises software executing on the server to link the user handle to at least one picture from a third-party social media site and to verify the at least one picture of the user in order to verify the authenticity of the user handle.

In certain embodiments, the system further comprises software executing on the server that includes reverse image search technology or links to a site that provides reverse image search technology in order to verify the authenticity of the user handle.

In certain embodiments, the system further comprises software executing on the server to receive additional information from the user and to verify the additional information from the user.

In certain embodiments, the additional information is selected from a group consisting of phone number, email, birth year, date of birth, occupation, and/or other personal information.

In certain embodiments, the user handle is linked to at least one picture from two or more third-party social media sites.

In certain embodiments, the server is a server for a dating website.

In certain embodiments, the server stores a database and records on the database are compared against one another during the identity test. In certain embodiments, the database includes logical tables including a plurality of rows and columns to store information and such information is stored and used to during the identity test.

In certain embodiments, the system has means for conducting the identity test using various software and multiple software packages.

In certain embodiments, the system has means for configuring and storing memory in a logical table, such that the information in the logical table is used and indexed and used during the identity test to verify a user's identity.

These and other objects of the invention are achieved by providing a method for verifying a user identity, the method comprising the steps of: registering a user handle, the user handle associated with a particular user identity; conducting an identity test to verify the authenticity of the user handle; and awarding an electronic confirmation that the user identity has been verified to be authentic. In certain embodiments, the method is a computer-implementable method.

In certain embodiments, the user handle is linked to at least one picture from a third-party social media site.

In certain embodiments, the identity test involves verifying the at least one picture of the user, where the user is required to take the picture in a specified way within a specified amount of time in order to verify the authenticity of the user handle.

In certain embodiments, the identity test requires reverse image search technology or links to a site that provides reverse image search technology in order to verify the authenticity of the user handle.

In certain embodiments, the user handle is linked to additional information from the user.

In certain embodiments, the identity test involves verifying the additional information from the user.

In certain embodiments, the additional information is selected from a group consisting of phone number, email, birth year, date of birth, occupation, and/or other personal information.

In certain embodiments, the user handle is linked to at least one picture from two or more third-party social media sites.

In certain embodiments, the method is performed on a dating website.

In certain embodiments, the identity test involves comparing at least two pieces of information and using at least two comparisons of the information to determine whether the identity test has been satisfied. In certain embodiments, the at least two comparisons involve information from different sources of information.

These and other objects of the invention are achieved by providing a non-transitory computer readable storage medium storing a program executed by a computer for verifying a user identity, the non-transitory computer readable storage medium comprising instructions for: registering a user handle, the user handle associated with a particular user identity; conducting an identity test to verify the authenticity of the user handle; and awarding an electronic confirmation that the user identity has been verified to be authentic.

In certain embodiments, the non-transitory computer readable storage medium comprises additional instructions and is sufficient to perform various methods and systems described in this specification.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention

### BRIEF DESCRIPTION OF THE DRAWINGS

FIG. 1 is a flowchart of a method of an embodiment of the application;

FIG. 2 is a schematic view of a system of an embodiment of the invention;

FIG. 3 is a flowchart of a method for conducting an identity test of an embodiment of the invention; and

FIG. 4 is a schematic view of a system of an embodiment of the invention.

### DETAILED DESCRIPTION OF THE INVENTION

In the following description, numerous details are set forth for purpose of explanation. However, one of ordinary skill in the art will realize that the invention may be practiced without the use of these specific details. For instance, the techniques described below are described in a specified order, but other embodiments may change the order of the operations while still embodying the current invention.

The invention is very valuable to social media sites, dating sites and throughout the Internet. The invention is directed to helping social media, dating and other Internet sites to verify the authenticity of users.

Other objects of the invention involve allowing a person to verify the identity of another person prior to meeting that person in real life. Other objects of the invention involve providing additional security to prevent a person from being duped on the Internet.

Such systems and methods can be performed on a new website or can be incorporated into an existing website in order to verify the identity of a user.

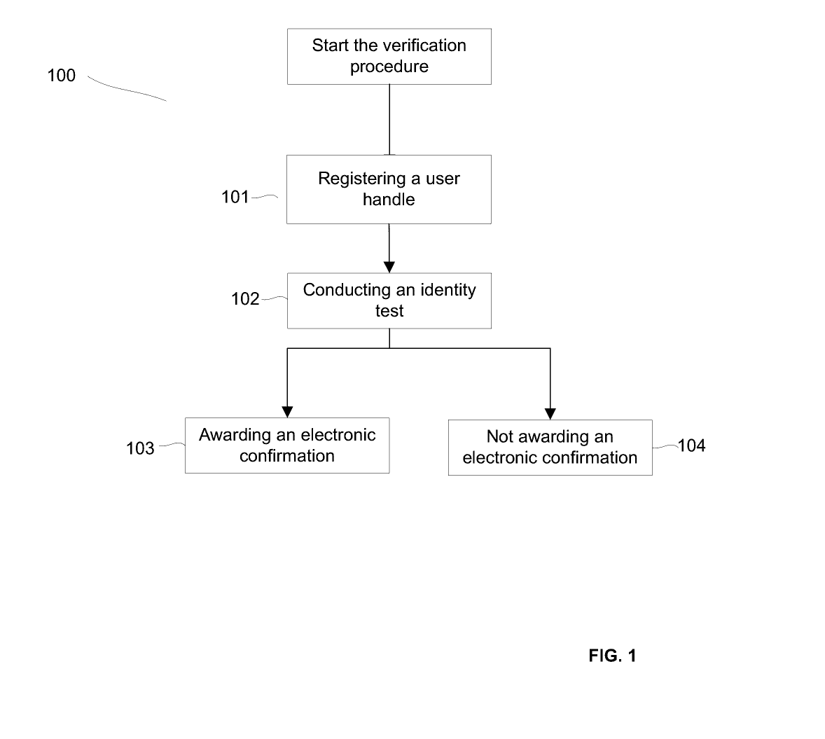

Referring to FIG. 1, a method 100 for verifying a user identity is provided. The method 100 includes the steps of: registering a user handle 101, the user handle associated with a particular user identity; conducting an identity test 102 to verify the authenticity of the user handle; and awarding an electronic confirmation 103 that the user identity has been verified to be authentic.

Creation of a User Handle

In certain embodiments, users will be able to login to a website by creating a username and password through the site or the users Facebook and/or Google+ credentials.

In certain embodiments, the username is the user handle, such that a particular user handle is associated with a user. In certain embodiments, users will be able to register various user handles and pictures from the many different social media sites.

In certain embodiments, users will visit a website and “click” register to sign up for an account. Once the user “clicks” register they will enter pertinent information to create a user handle (user profile) which includes information such as name, email, social media handles, occupation, etc. The user will submit this information on the website they will submit the information.

In certain embodiments, once the information is entered on the website, a verification email will be automatically generated to the email address provided by the user.

Identity Test and Awarding Electronic Approval

After the user creates the user handle, the method and system involves having the user pass one or more identity tests, so that the user will receive a “verified” stamp of approval.

One of the ways to verify the authenticity of a user includes verifying a picture of the user, and requesting that the user take a specific photo or holding a specific item or in a specified way within a certain amount of time. This ensures a human quality to the photograph, so that a person that is catfishing would most likely not be able to get a specific picture of the person they are perpetrating, in a relatively short amount of time.

In certain embodiments, the amount of time to get a picture is a few minutes. In certain embodiments, the amount of time to get a picture will be under a minute or a few seconds.

In certain embodiments, the methods and systems provide instructions for the user to take a picture in a certain way, such as a profile view of a user's face from the right or left side of the face and at a certain distance from the camera.

In other embodiments, videos are used to verity the authenticity of users. In certain embodiments, a video is compared against a video on a third party website in order to verify the authenticity of users.

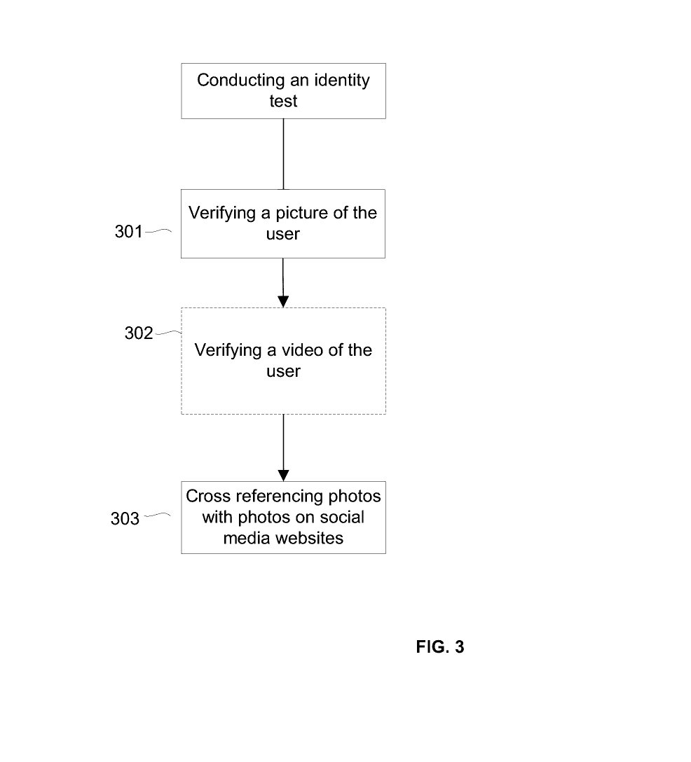

Referring to FIG. 3, such a method is shown whereby the method involves the steps of verifying a picture of the user 301, verifying a video of the user 302 and/or cross referencing photos and videos with photos on social media websites. In certain embodiments, software is used to cross reference the pictures and videos and use image recognition technology.

In certain embodiments, once the photos and/or videos are sent over to the site, the photos and/or videos used in the verification process are evaluated within software that checks if the photos and/or videos have been “photo shopped” or the photos and/or videos contain any “white noise”. The software executes to evaluate the pictures and compare the pictures against other pictures in a database and/or another website.

In certain embodiments, there are additional verification tests to help verify a user handle. In certain embodiments, the methods and systems include software that cross references photos and/or videos on the users social media sites with the photos and/or videos used for the verification process, and then evaluates the photos and/or videos through a form of facial recognition software to help confirm the photos and/or videos correspond to the same person.

If any of the users pictures and/or videos have failed any of the verification tests, then they are rejected from the site and any name or social media handle associated with a “non-verified stamp” from the site.

If the photos and/or videos are “verified”, an email will be sent to the users email address used when creating a profile on the site, advising them that the verification process is complete and that they are now “verified”. Users can also see that they have been “verified” by logging into the account associated with the user.

Once the users are “verified” they will be able to log into their account and search other users to find out if they are “verified”. In certain embodiments, registered users will also be able to search other usernames and pictures to find out if they have been “verified” by the website and received a stamp of approval.

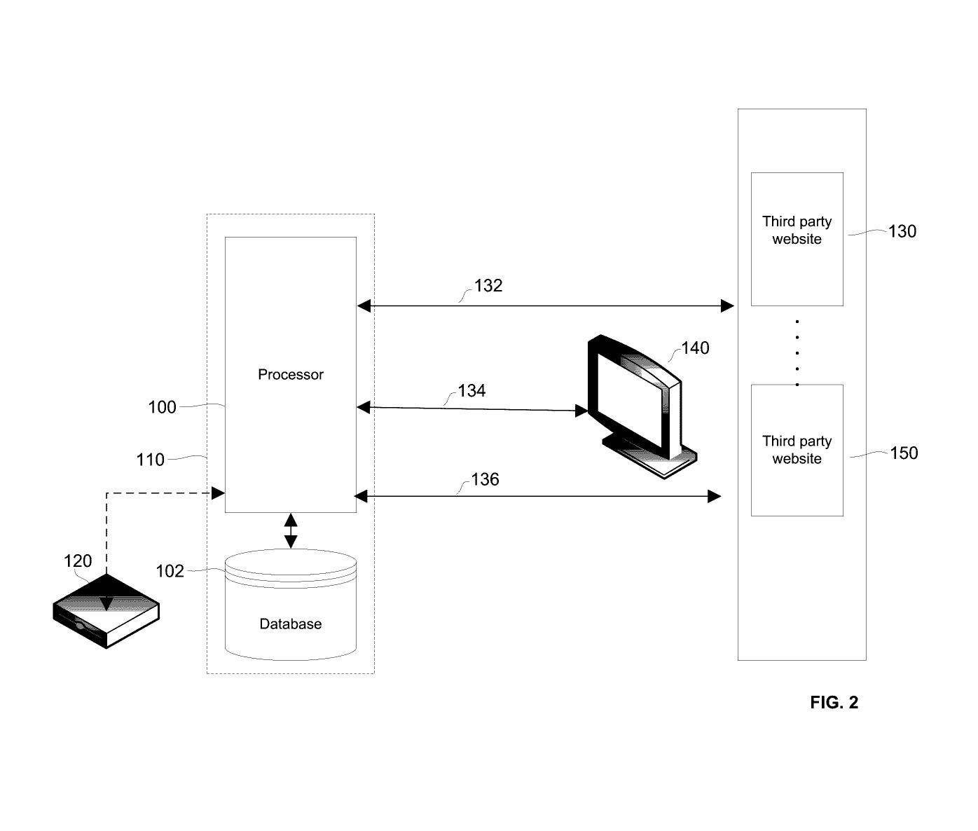

Referring to FIG. 2, a system to process this method is shown. The system includes a server 110, a computer 100 and software that executes various functionality. The computer includes a processor able to run the software and a memory and non-transient computer readable storage medium able to include instructions for running software.

FIG. 2 also shows a database 102 connected to the processor as well as a display 140 connected to the processor via a link 134. One or more third party websites 130 and 150 are accessed by the software executing on the processor via links 132 and 136. These websites are accessed when the software executing on the server cross references photos or video stores on one or more third party websites in order to verify a user handle.

In certain embodiments, the invention uses a reverse image search technology or links to a site that provides this service, i.e. Google reverse image in order to verify a user handle. In certain embodiments, the reverse image technology is stored on the server and in other embodiments, it is stored on the Internet or on a third party website.

Identity Test of Additional Information

In certain embodiments, the methods and systems of the invention allow for the verification of various user information in additional to picture and/or video verification.

In certain embodiments, the methods and systems involve the verification of phone number, email, birth year, date of birth, occupation, and/or other personal information. In certain embodiments, software executing on the server

In certain embodiments, upon receiving a verification email, the user can either click a link to be forwarded to the site where they would be able to take photos and/or videos with either their webcam or phone camera which would be outlined in the email to become verified, OR if no webcam or phone camera is available, they would be able to upload specific photos and/or videos videos outlined by the email and attach it to a reply email in a timed manner to become “verified”.

In certain embodiments, the methods and systems asks for a fee or a paid membership in order to verify various levels of information, so that authenticity is increased. In certain embodiments, a fee or paid membership allows for additional information of a user to be “verified” so that there is a higher confidence of a user's identity.

In certain embodiments, users also have the option to upgrade from a free user membership to different paid user membership packages, which will allow them to find out more information about other users, find out other users who have searched them, and/or search an unlimited amount of users.

User Interaction

In certain embodiments, users can also directly communicate through the website or app with text like messages, instant like messages, and send images and/or video messages. In certain embodiments, such communication channels allow users to communicate with one another and allows a user once being “verified” to be in a user network, such as a dating website.

In certain embodiments, the method and system involves social networking and data websites. In certain embodiments, the methods and systems of the invention are incorporated into a third party website for verification purposes of user handles and in other embodiments, the user is directed to a specific website used for verification purposes.

Computer System

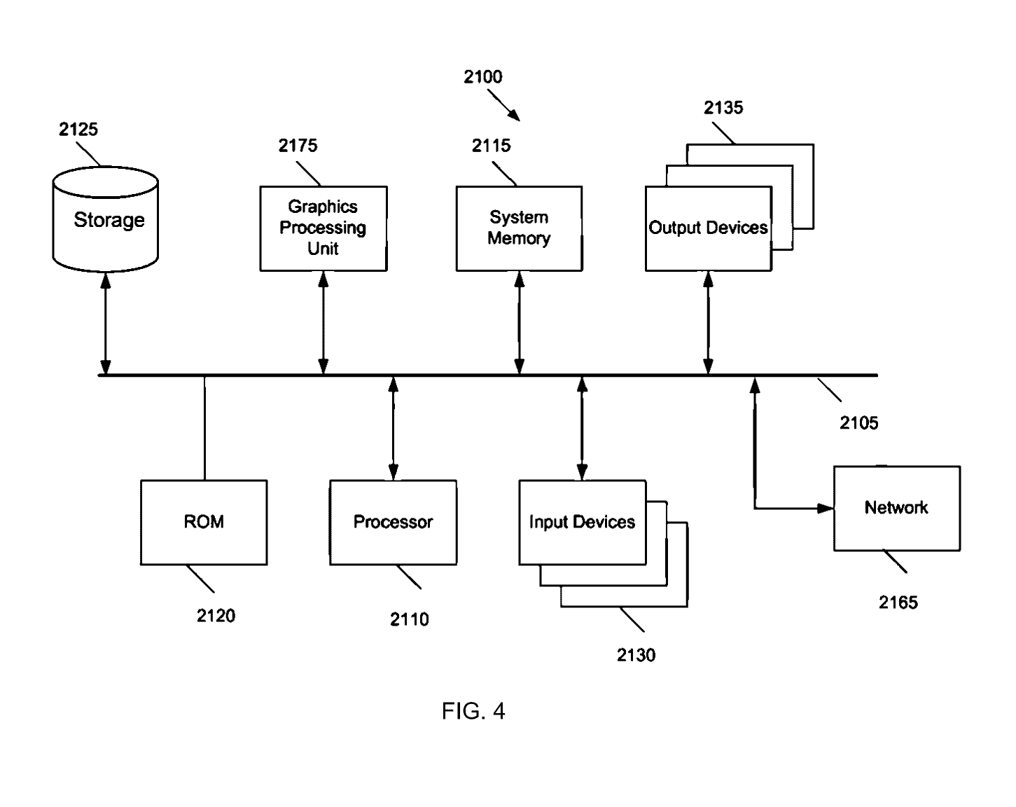

FIG. 4 conceptually illustrates a computer system with which some embodiments of the invention are implemented. The computer system 2100 includes a bus 2105, a processor 2110, a system memory 2115, a read-only memory 2120, a permanent storage device 2125, input devices 2130, and output devices 2135. In some embodiments, the computer system also includes a graphic processing unit (GPU) 2175.

The bus 2105 collectively represents all system, peripheral, and chipset buses that support communication among internal devices of the computer system 2100. For instance, the bus 2105 communicatively connects the processor 2110 with the read-only memory 2120, the system memory 2115, and the permanent storage device 2125.

From these various memory units, the processor 2110 (also referred to as central processing unit or CPU) retrieves instructions to execute and data to process in order to execute the processes of the invention. The read-only-memory (ROM) 2120 stores static data and instructions that are needed by the processor 2110 and other modules of the computer system.

The permanent storage device 2125, on the other hand, is a read-and-write memory device. This device is a non-volatile memory unit that stores instruction and data even when the computer system 2100 is off. Some embodiments of the invention use a mass-storage device (such as a magnetic or optical disk and its corresponding disk drive) as the permanent storage device 2125. The permanent storage device 2125 may be a fully solid-state storage, a conventional “spinning magnetic pallet” storage (i.e. hard-drive), or combinations thereof.

Other embodiments may use a removable storage device (such as a USB flash drive or SD Memory Card) as a temporary storage or as the permanent storage device 2125.

Like the permanent storage device 2125, the system memory 2115 is a read and write memory device. However, unlike storage device 2125, the system memory is a volatile read-and-write memory, such as a random access memory. The system memory stores at least some of the instructions and data that the processor needs at runtime.

Instructions and/or data needed to perform processes of some embodiments are stored in the system memory 2115, the permanent storage device 2125, the read-only memory 2120, or any combination of the three. For example, the various memory units may contain instructions for processing multimedia items in accordance with some embodiments. From these various memory units, the processor 2110 retrieves instructions to execute and data to process in order to execute the processes of some embodiments.

The bus 2105 also connects to the input and output devices 2130 and 2135. The input devices enable the user to communicate information and select commands to the computer system. The input devices 2130 include alphanumeric keyboards, touch panels, and cursor controllers. The input devices 2130 also include scanners through which an image can be input to the computer system. The output devices 2135 display images generated by the computer system. The output devices may include printers, pen plotters, laser printers, ink-jet plotters, film recorders, and display devices, such as cathode ray tubes (CRT), liquid crystal displays (LCD), or electroluminescent displays.

As shown in FIG. 4, bus 2105 also couples computer 2100 to a network 2165 through a network adapter (not shown). In this manner, the computer can be a part of a network of computers (such as a local area network (“LAN”), a wide area network (“WAN”), or an Intranet) or a network of networks (such as the Internet). Finally, as shown in FIG. 4, the computer system in some embodiments also optionally includes a graphics processing unit (GPU) 2175. A GPU (also referred to as a visual processing unit or a display processor) is a dedicated graphics rendering device which is very efficient in manipulating and displaying computer graphics. The GPU can be included in a video card (not shown) or can be integrated into the mother board of the computer system along with the processor 2110. Also, the computer system 2100 may be used as a personal computer, a workstation, a game console, or the like. Any or all of the components of computer system 2100 may be used in conjunction with the invention. However, one of ordinary skill in the art will appreciate that any other system configuration may also be used in conjunction with the invention.

While the invention has been specifically described in connection with certain specific embodiments thereof, it is to be understood that this is by way of illustration and not of limitation and that various changes and modifications in form and details may be made thereto, and the scope of the appended claims should be construed as broadly as the prior art will permit.

The description of the invention is merely exemplary in nature, and thus, variations that do not depart from the gist of the invention are intended to be within the scope of the invention. Such variations are not to be regarded as a departure from the spirit and scope of the invention

What is claimed is:

1. A system for verifying a user identity, the system comprising:
a server;
at least one database in communications with said server;
at least one computer in communication with said server via the Internet;
software executing on said server to receive a user handle from the at least one computer, the user handle associated with a particular user identity;
software executing on said server to conduct an identity test to verify the authenticity of the user handle; and
software executing on said server to award an electronic confirmation that the user identity has been verified to be authentic and transmitting the award notification to said at least one computer.

2. The system of claim 1, further comprising software executing on the server to link the user handle to at least one picture from a third-party social media site and to verify the at least one picture of the user in order to verify the authenticity of the user handle.

3. The system of claim 1, further comprising software executing on the server that includes reverse image search technology or links to a site that provides reverse image search technology in order to verify the authenticity of the user handle.

4. The system of claim 1, further comprising software executing on the server to receive additional information from the user and to verify the additional information from the user.

5. The system of claim 4, wherein the additional information is selected from a group consisting of phone number, email, birth year, date of birth, occupation, and/or other personal information.

6. The system of claim 1, wherein the user handle is linked to at least one picture from two or more third-party social media sites.

7. The system of claim 1, wherein the server is a server for a dating website.

8. A method for verifying a user identity, the method comprising the steps of:
registering a user handle, the user handle associated with a particular user identity;
conducting an identity test to verify the authenticity of the user handle; and
awarding an electronic confirmation that the user identity has been verified to be authentic.

9. The method claim 1, wherein the user handle is linked to at least one picture from a third-party social media site.

10. The method of claim 9, wherein the identity test involves verifying the at least one picture of the user, where the user is required to take the picture in a specified way within a specified amount of time in order to verify the authenticity of the user handle.

11. The method of claim 9, wherein the identity test requires reverse image search technology or links to a site that provides reverse image search technology in order to verify the authenticity of the user handle.

12. The method of claim 1, wherein the user handle is linked to additional information from the user.

13. The method of claim 12, wherein the identity test involves verifying the additional information from the user.

14. The method of claim 13, wherein the additional information is selected from a group consisting of phone number, email, birth year, date of birth, occupation, and/or other personal information.

15. The method of claim 1, wherein the user handle is linked to at least one picture from two or more third-party social media sites.

16. The method of claim 1, wherein the method is performed on a dating website.

17. A non-transitory computer readable storage medium storing a program executed by a computer for verifying a user identity, the non-transitory computer readable storage medium comprising instructions for:
registering a user handle, the user handle associated with a particular user identity;
conducting an identity test to verify the authenticity of the user handle; and
awarding an electronic confirmation that the user identity has been verified to be authentic.
